(19) United States
(12) Patent Application Publication
(10) Pub. No.: US 2017/0052950 A1
(43) Pub. Date: Feb. 23, 2017

(54) EXTRACTING INFORMATION FROM STRUCTURED DOCUMENTS COMPRISING NATURAL LANGUAGE TEXT

(71) Applicant: ABBYY InfoPoisk LLC, Moscow (RU)

(72) Inventors: Tatiana Danielyan, Moscow (RU); Ilya Bulgakov, Barnaul (RU)

(21) Appl. No.: 14/868,715

(22) Filed: Sep. 29, 2015

(30) Foreign Application Priority Data
Aug. 19, 2015 (RU) 2015135006

(51) Int. Cl. G06F 17/27; G06F 17/24

(52) U.S. Cl. CPC G06F 17/2785; G06F 17/271; G06F 17/245

(57) ABSTRACT

Systems and methods for extracting information from structured documents comprising natural language text. An example method comprises: receiving a table comprising a natural language text; identifying, within the table, a header and a plurality of cells organized into rows and columns; performing semantico-syntactic analysis of the natural language text to produce a plurality of semantic structures; interpreting the plurality of semantic structures using a first set of production rules to produce a data object representing the table; analyzing the header to identify a plurality of ontology classes associated with respective table columns; and modifying the data object representing the table using a second set of production rules associated with the ontology classes associated with the table columns.

### CROSS REFERENCE TO RELATED APPLICATIONS

The present application claims the benefit of priority under 35 USC 119 to Russian Patent Application No. 2015135006, filed Aug. 19, 2015; the disclosure of which is herein incorporated by reference in its entirety for all purposes.

### TECHNICAL FIELD

The present disclosure is generally related to computer systems, and is more specifically related to systems and methods for natural language processing.

### BACKGROUND

Natural language text may be structured by a tabular form. A table may comprise a plurality of cells organized into rows and columns. At least some of the cells may comprise natural language text. A table may further comprise a header comprising at least one header cell per one or more table columns. The header cell may comprise a description, definition, or other information associated with each cell of the corresponding column.

### SUMMARY OF THE DISCLOSURE

In accordance with one or more aspects of the present disclosure, an example method may comprise: receiving a table comprising a natural language text; identifying, within the table, a header and a plurality of cells organized into rows and columns; performing semantico-syntactic analysis of the natural language text to produce a plurality of semantic structures; interpreting the plurality of semantic structures using a first set of production rules to produce a data object representing the table; analyzing the header to identify a plurality of ontology classes associated with respective table columns; and modifying the data object representing the table using a second set of production rules associated with the ontology classes associated with the table columns.

In accordance with one or more aspects of the present disclosure, an example system may comprise: a memory; a processor, coupled to the memory, the processor configured to: receive a table comprising a natural language text; identify, within the table, a header and a plurality of cells organized into rows and columns; perform semantico-syntactic analysis of the natural language text to produce a plurality of semantic structures; interpret the plurality of semantic structures using a first set of production rules to produce a data object representing the table; analyze the header to identify a plurality of ontology classes associated with respective table columns; and modify the data object representing the table using a second set of production rules associated with the ontology classes associated with the table columns.

In accordance with one or more aspects of the present disclosure, an example computer-readable non-transitory storage medium may comprise executable instructions that, when executed by a computing device, cause the computing device to perform operations comprising: receiving a table comprising a natural language text; identifying, within the table, a header and a plurality of cells organized into rows and columns; performing semantico-syntactic analysis of the natural language text to produce a plurality of semantic structures; interpreting the plurality of semantic structures using a first set of production rules to produce a data object representing the table; analyzing the header to identify a plurality of ontology classes associated with respective table columns; and modifying the data object representing the table using a second set of production rules associated with the ontology classes associated with the table columns.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a flow diagram of one illustrative example of a method for extracting information from structured documents comprising natural language text, in accordance with one or more aspects of the present disclosure;

FIG. 2 depicts a flow diagram of one illustrative example of a method 200 for performing a semantico-syntactic analysis of a natural language sentence 212, in accordance with one or more aspects of the present disclosure.

FIG. 3 schematically illustrates an example of a lexico-morphological structure of a sentence, in accordance with one or more aspects of the present disclosure;

FIG. 4 schematically illustrates language descriptions representing a model of a natural language, in accordance with one or more aspects of the present disclosure;

FIG. 5 schematically illustrates examples of morphological descriptions, in accordance with one or more aspects of the present disclosure;

FIG. 6 schematically illustrates examples of syntactic descriptions, in accordance with one or more aspects of the present disclosure;

FIG. 7 schematically illustrates examples of semantic descriptions, in accordance with one or more aspects of the present disclosure;

FIG. 8 schematically illustrates examples of lexical descriptions, in accordance with one or more aspects of the present disclosure;

FIG. 9 schematically illustrates example data structures that may be employed by one or more methods implemented in accordance with one or more aspects of the present disclosure;

FIG. 10 schematically illustrates an example graph of generalized constituents, in accordance with one or more aspects of the present disclosure;

FIG. 11 illustrates one of syntactic structures corresponding to the sentence illustrated by FIG. 10;

FIG. 12 illustrates a semantic structure corresponding to the syntactic structure of FIG. 11;

FIG. 13 schematically illustrates several statements types that may be employed in the information extraction process, in accordance with one or more aspects of the present disclosure;

FIG. 14 schematically illustrates the process of interpreting the semantic structures produced by the semantico-syntactic analysis in accordance with one or more aspects of the present disclosure;

FIG. 15 schematically illustrates an example auxiliary ontology comprising various classes associated with certain aspects of the table structure, in accordance with one or more aspects of the present disclosure;

FIG. 16A schematically illustrates example tables and rules employed for processing the table headers, in accordance with one or more aspects of the present disclosure;

FIG. 16B schematically illustrates example tables and rules employed for processing the table headers, in accordance with one or more aspects of the present disclosure;

FIG. 17 schematically illustrates an example table and a set of rules employed for processing the table body, in accordance with one or more aspects of the present disclosure;

FIG. 18 depicts a diagram of an example computing device implementing the methods described herein.

### DETAILED DESCRIPTION

Described herein are methods and systems for extracting information from structured documents (e.g., documents comprising tables, documents having multi-level structure comprising sections and sub-sections, etc.) comprising natural language text.

Information extraction is one of the important operations in automated processing of natural language texts. Information extracted from a natural language document may be represented by one or more information objects comprising definitions of objects, relationships of the objects, and/or statements associated with the objects. In certain implementations, the information objects may be provided by Resource Definition Framework (RDF) graphs, as described in more details herein below.

Information in certain documents may be structured using various methods. In an illustrative example, a document may comprise one or more tables, such that each table may comprise a plurality of cells organized into rows and columns. At least some of the cells may comprise natural language text. A table may further comprise a header comprising at least one header cell per one or more table columns. The header cell may comprise a description, definition, or other information associated with each cell of the corresponding column. Thus, the information comprised by the table cells may be enhanced by certain information (such as of relationships between one or more objects being described by the table cells) that may be retrieved from the table header.

The present disclosure provides system and methods for extracting, by a computing device, information from structured documents (e.g., documents comprising tables, documents having multi-level structure comprising sections and sub-sections, etc.) comprising natural language text.

“Computing device” herein shall refer to a data processing device having a general purpose processor, a memory, and at least one communication interface. Examples of computing devices that may employ the methods described herein include, without limitation, desktop computers, notebook computers, tablet computers, and smart phones.

Information extraction methods implemented in accordance with one or more aspects of the present disclosure may represent the extracted information in accordance with certain pre-defined or dynamically built ontologies. “Ontology” herein shall refer to a model representing objects pertaining to a certain branch of knowledge (subject area) and relationships among such objects. An ontology may comprise definitions of a plurality of classes, such that each class corresponds to a concept of the subject area. Each class definition may comprise definitions of one or more objects associated with the class. Following the generally accepted terminology, an ontology class may also be referred to as concept, and an object belonging to a class may also be referred to as an instance of the concept.

In an illustrative example, class “Person” may be associated with one or more objects corresponding to certain persons. Each class definition may further comprise one or more relationship definitions describing the types of relationships that may be associated with the objects of the class. Each class definition may further comprise one or more restrictions defining certain properties of the objects of the class. In certain implementations, a class may be an ancestor or a descendant of another class.

An object definition may represent a real life material object (such as a person or a thing) or a certain characteristics associated with one or more real life objects (such as a number or a word). In certain implementations, an object may be associated with two or more classes. An ontology may be an ancestor or/and a descendant of another ontology, in which case concepts and properties of the ancestor ontology would also pertain to the descendant ontology.

In accordance with one or more aspects of the present disclosure, the computing device implementing the method may analyze a table comprising a natural language text to determine the table structure. In particular, the computing device may identify the table header and a plurality of cells organized into rows and columns.

The computing device may then perform syntactic and semantic analysis of the natural language text comprised by the table cells, using a wide set of language-independent and language specific linguistic descriptions. The syntactic and sematic analysis may yield one or more language independent semantic structures representing the information comprised by the table cells.

The computing device may then extract the information from the plurality of semantic structures using a generic or subject matter-specific ontology associated with the subject matter presented in the table and structure-independent production rules (i.e., without taking the table structure into account). Each production rule may comprise a set of logical expressions defined on one or more semantic structure templates. In certain implementations, the information extracted from the table cells may be represented by a data objects (such as a Resource Data Framework (RDF) graph).

The computing device may then process the table header. In particular, the computing device may identify a plurality of ontology classes associated with the respective table columns, using a generic ontology and/or a subject matter-related ontology associated with the subject matter of the document. In analyzing the table header, the computing device may further employ an auxiliary ontology comprising various classes associated with certain aspects of the table structure.

The computing device may then enhance the data object (e.g., the RDF graph) that was previously built by extracting the information from the table cells without taking into account the table structure. In particular, the computing device may apply, to the information extracted from the table cells, certain production rules associated with the plurality of ontology classes defined by the table header.

Various aspects of the above referenced methods and systems are described in details herein below by way of examples, rather than by way of limitation.

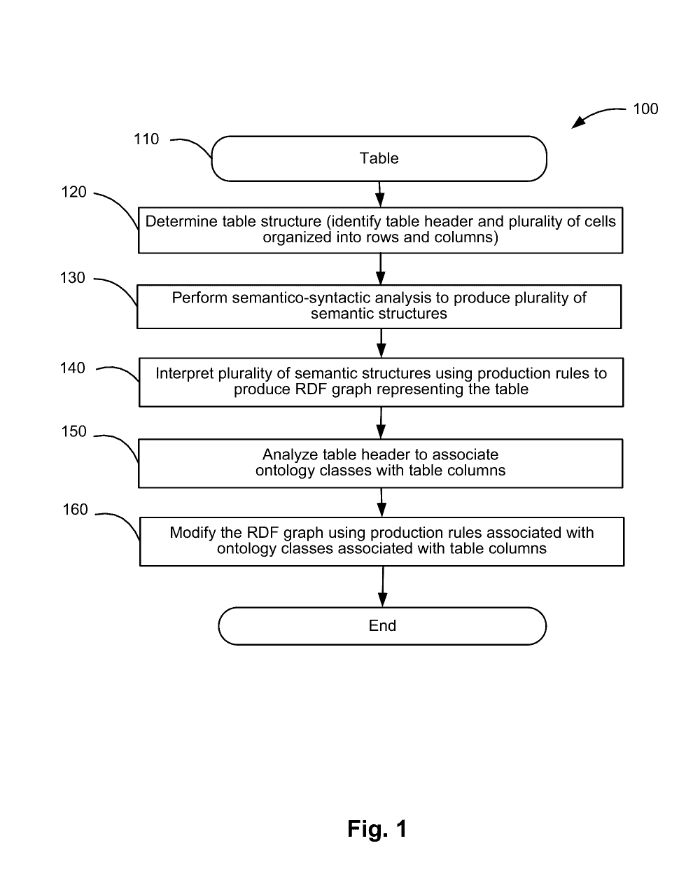

FIG. 1 depicts a flow diagram of one illustrative example of a method 100 for extracting information from structured documents comprising natural language text, in accordance with one or more aspects of the present disclosure. Method 100 and/or each of its individual functions, routines, subroutines, or operations may be performed by one or more processors of the computing device implementing the method. In certain implementations, method 100 may be performed by a single processing thread. Alternatively, method 100 may be performed by two or more processing threads, each thread implementing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other.

At block 120, the computing device implementing the method may analyze a table 110 comprising a natural language text to determine the table structure. In certain implementations, the computing device may identify the one or more table header and a plurality of cells organized into rows and columns, as described in more details herein below.

At block 130, the computing device may perform syntactic and semantic analysis of the natural language text comprised by the table cells, using language-independent and language specific linguistic descriptions. The syntactic and sematic analysis may yield one or more language independent semantic structures representing the information comprised by the table cells.

At block 140, the computing device may interpret the plurality of semantic structures using structure-independent production rules (i.e., without taking the table structure into account) and a generic or subject matter-specific ontology associated with the subject matter presented in the table. Each production rule may comprise a set of logical expressions defined on one or more semantic structure templates. In certain implementations, the information extracted from the table cells by applying the production rules may be represented by a data object (such as a Resource Data Framework (RDF) graph).

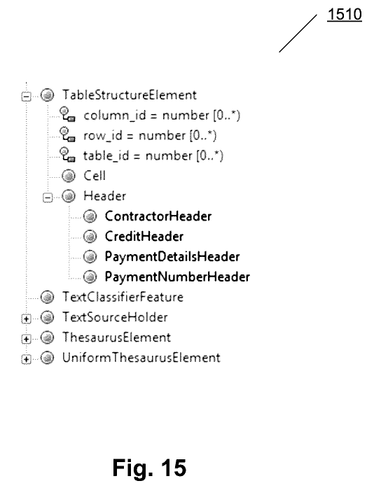

At block 150, the computing device may analyze the table header to associate at least one table column with one or more classes of a certain generic or subject matter-specific ontology associated with the subject matter presented in the table. In certain implementations, the computing device may use an auxiliary ontology (for example, ontology 1510 of FIG. 15) that comprises various classes associated with various aspects of document structure, to facilitate analyzing the table header.

At block 160, the computing device may modify the data objects (e.g., the RDF graph) that was built by extracting the information from the table cells. In particular, the data objects may be enhanced by applying, to the information extracted from the table cells, certain production rules associated with the ontology classes associated with the table columns.

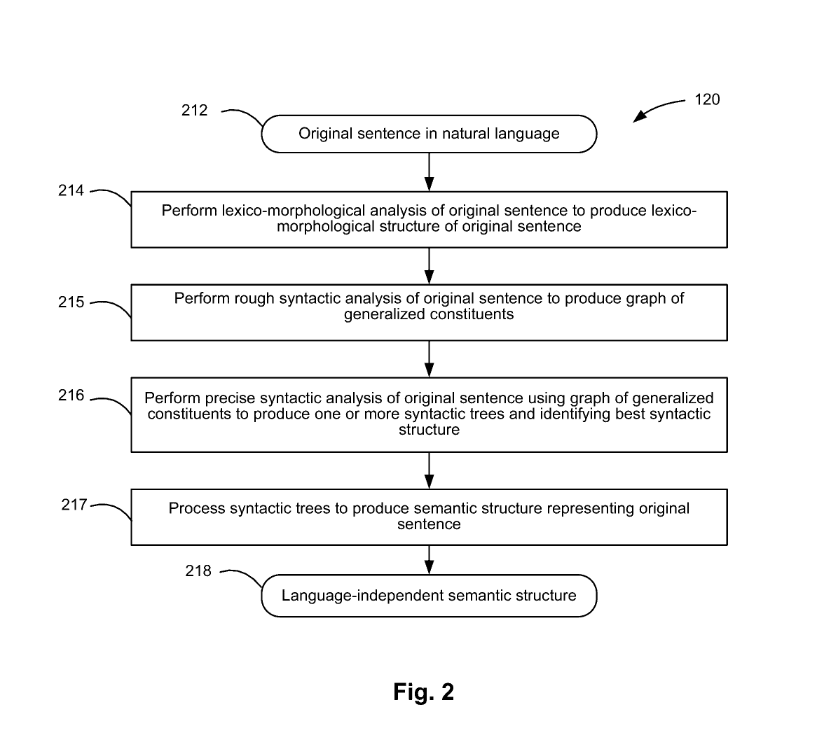

FIG. 2 depicts a flow diagram of one illustrative example of a method 200 for performing a semantico-syntactic analysis of a natural language sentence 212, in accordance with one or more aspects of the present disclosure. Method 200 may be applied to one or more syntactic units (e.g., sentences) comprised by a certain text document or table comprising text, in order to produce a plurality of semantico-syntactic trees corresponding to the syntactic units.

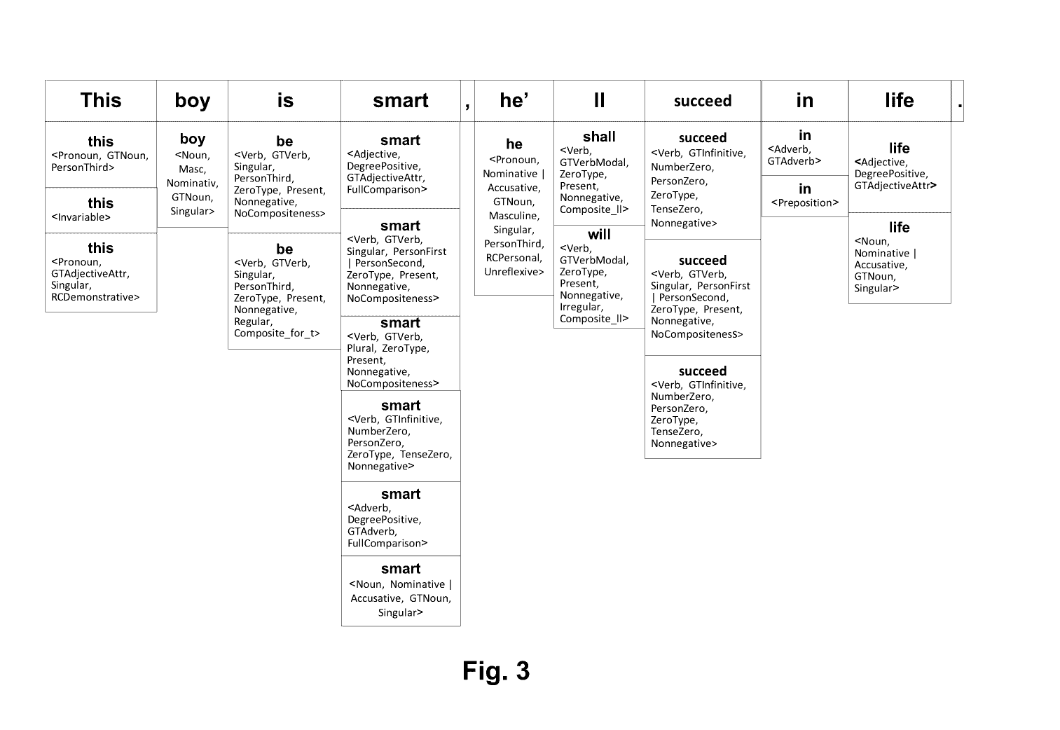

At block 214, the computing device implementing the method may perform lexico-morphological analysis of sentence 212 to identify morphological meanings of the words comprised by the sentence. “Morphological meaning” of a word herein shall refer to one or more lemma (i.e., canonical or dictionary forms) corresponding to the word and a corresponding set of values of grammatical attributes defining the grammatical value of the word. Such grammatical attributes may include the lexical category of the word and one or more morphological attributes (e.g., grammatical case, gender, number, conjugation type, etc.). Due to homonymy and/or coinciding grammatical forms corresponding to different lexico-morphological meanings of a certain word, two or more morphological meanings may be identified for a given word. An illustrative example of performing lexico-morphological analysis of a sentence is described in more details herein below with references to FIG. 3.

At block 215, the computing device may perform a rough syntactic analysis of sentence 212. The rough syntactic analysis may include identification of one or more syntactic models which may be associated with sentence 212 followed by identification of the surface (i.e., syntactic) associations within sentence 212, in order to produce a graph of generalized constituents. “Constituent” herein shall refer to a contiguous group of words of the original sentence, which behaves as a single grammatical entity. A constituent comprises a core represented by one or more words, and may further comprise one or more child constituents at lower levels. A child constituent is a dependent constituent and may be associated with one or more parent constituents.

At block 216, the computing device may perform a precise syntactic analysis of sentence 212, to produce one or more syntactic trees of the sentence. The pluralism of possible syntactic trees corresponding to a given original sentence may stem from homonymy and/or coinciding grammatical forms corresponding to different lexico-morphological meanings of one or more words within the original sentence. Among the multiple syntactic trees, one or more best syntactic tree corresponding to sentence 212 may be selected, based on a certain rating function talking into account compatibility of lexical meanings of the original sentence words, surface relationships, deep relationships, etc.

At block 217, the computing device may process the syntactic trees to the produce a semantic structure 218 corresponding to sentence 212. Semantic structure 218 may comprise a plurality of nodes corresponding to semantic classes, and may further comprise a plurality of edges corresponding to semantic relationships, as described in more details herein below.

FIG. 3 schematically illustrates an example of a lexico-morphological structure of a sentence, in accordance with one or more aspects of the present disclosure. Example lexical-morphological structure 300 may comprise having a plurality of “lexical meaning-grammatical value” pairs for example sentence 320. In an illustrative example, “ll” may be associated with lexical meaning “shall” 312 and “will” 314. The grammatical value associated with lexical meaning 312 is <Verb, GTVerbModal, ZeroType, Present, Nonnegative, Composite II>. The grammatical value associated with lexical meaning 314 is <Verb, GTVerbModal, ZeroType, Present, Nonnegative, Irregular, Composite II>.

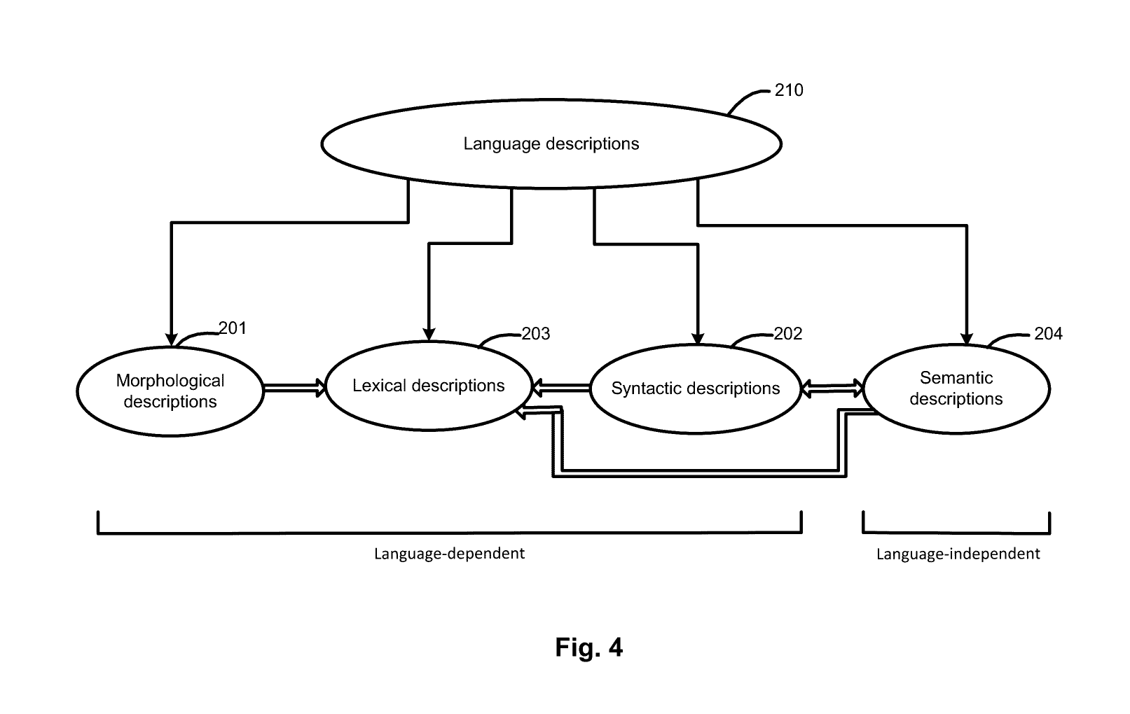

FIG. 4 schematically illustrates language descriptions 210 including morphological descriptions 201, lexical descriptions 203, syntactic descriptions 202, and semantic descriptions 204, and their relationship thereof. Among them, morphological descriptions 201, lexical descriptions 203, and syntactic descriptions 202 are language-specific. A set of language descriptions 210 represent a model of a certain natural language.

In an illustrative example, a certain lexical meaning of lexical descriptions 203 may be associated with one or more surface models of syntactic descriptions 202 corresponding to this lexical meaning. A certain surface model of syntactic descriptions 202 may be associated with a deep model of semantic descriptions 204.

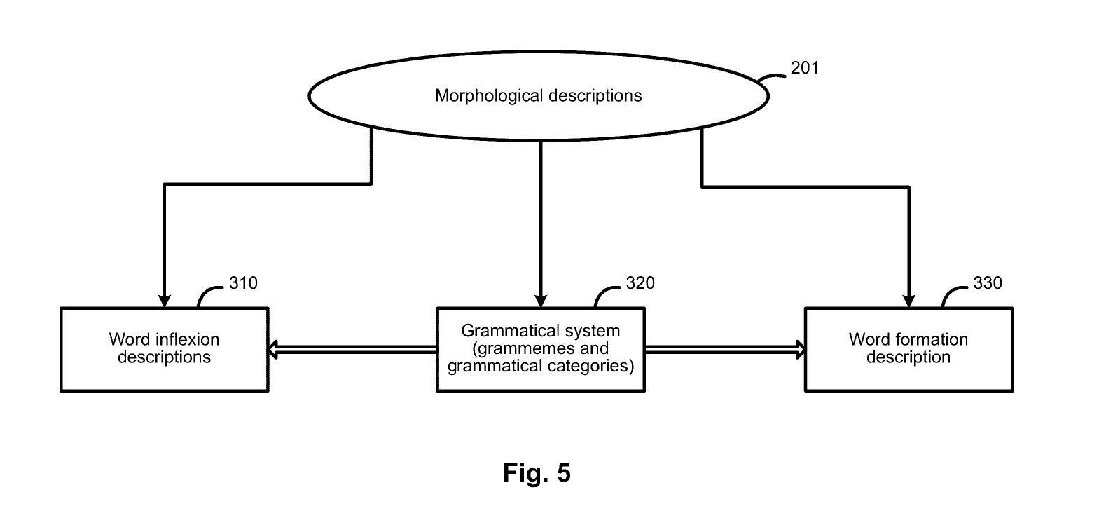

FIG. 5 schematically illustrates several examples of morphological descriptions. Components of the morphological descriptions 201 may include: word inflexion descriptions 310, grammatical system 320, and word formation description 330, among others. Grammatical system 320 comprises a set of grammatical categories, such as, part of speech, grammatical case, grammatical gender, grammatical number, grammatical person, grammatical reflexivity, grammatical tense, grammatical aspect, and their values (also referred to as “grammemes”), including, for example, adjective, noun, or verb; nominative, accusative, or genitive case; feminine, masculine, or neutral gender; etc. The respective grammemes may be utilized to produce word inflexion description 310 and the word formation description 330.

Word inflexion descriptions 310 describe the forms of a given word depending upon its grammatical categories (e.g., grammatical case, grammatical gender, grammatical number, grammatical tense, etc.), and broadly includes or describes various possible forms of the word. Word formation description 330 describes which new words may be constructed based on a given word (e.g., compound words).

According to one aspect of the present disclosure, syntactic relationships among the elements of the original sentence may be established using a constituent model. A constituent may comprise a group of neighboring words in a sentence that behaves as a single entity. A constituent has a word at its core and may comprise child constituents at lower levels. A child constituent is a dependent constituent and may be associated with other constituents (such as parent constituents) for building the syntactic descriptions 202 of the original sentence.

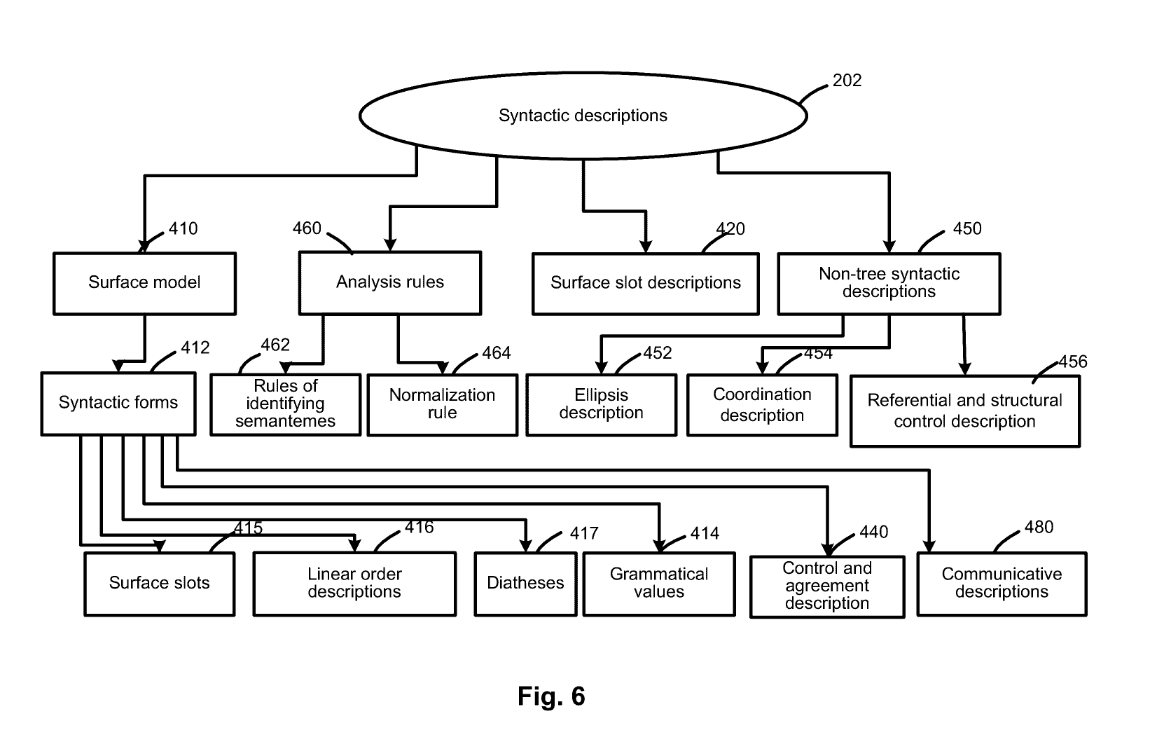

FIG. 6 illustrates exemplary syntactic descriptions. The components of the syntactic descriptions 202 may include, but are not limited to, surface models 410, surface slot descriptions 420, referential and structural control description 456, control and agreement description 440, non-tree syntactic description 450, and analysis rules 460. Syntactic descriptions 202 may be used to construct possible syntactic structures of the original sentence in a given natural language, taking into account free linear word order, non-tree syntactic phenomena (e.g., coordination, ellipsis, etc.), referential relationships, and other considerations.

Surface models 410 may be represented as aggregates of one or more syntactic forms (“syntforms” 412) employed to describe possible syntactic structures of the sentences that are comprised by syntactic descriptions 202. In general, the lexical meaning of a natural language word may be linked to surface (syntactic) models 410. A surface model may represent constituents which are viable when the lexical meaning functions as the “core.” A surface model may include a set of surface slots of the child elements, a description of the linear order, and/or diatheses. “Diathesis” herein shall refer to a certain relationship between an actor (subject) and one or more objects, having their syntactic roles defined by morphological and/or syntactic means. In an illustrative example, a diathesis may be represented by a voice of a verb: when the subject is the agent of the action, the verb is in the active voice, and when the subject is the target of the action, the verb is in the passive voice.

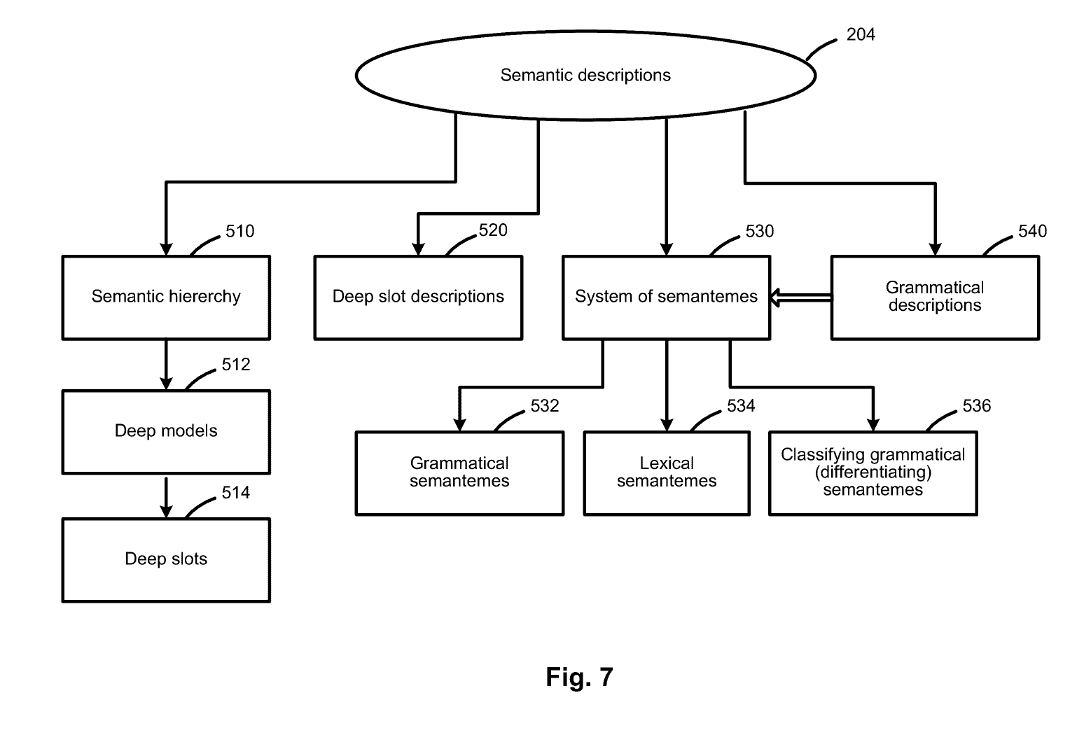

A constituent model may utilize a plurality of surface slots 415 of the child constituents and their linear order descriptions 416 to describe grammatical values 414 of possible fillers of these surface slots. Diatheses 417 may represent relationships between surface slots 415 and deep slots 514 (as shown in FIG. 7). Communicative descriptions 480 describe communicative order in a sentence.

Linear order description 416 may be represented by linear order expressions reflecting the sequence in which various surface slots 415 may appear in the sentence. The linear order expressions may include names of variables, names of surface slots, parenthesis, grammemes, ratings, the “or” operator, etc. In an illustrative example, a linear order description of a simple sentence of “Boys play football” may be represented as “Subject Core Object_Direct,” where Subject, Core, and Object_Direct are the names of surface slots 415 corresponding to the word order.

Communicative descriptions 480 may describe a word order in a syntform 412 from the point of view of communicative acts that are represented as communicative order expressions, which are similar to linear order expressions. The control and concord descriptions 440 may comprise rules and restrictions which are associated with grammatical values of the related constituents and may be used in performing syntactic analysis.

Non-tree syntax descriptions 450 may be created to reflect various linguistic phenomena, such as ellipsis and coordination, and may be used in syntactic structures transformations which are generated at various stages of the analysis according to one or more aspects of the present disclosure. Non-tree syntax descriptions 450 may include ellipsis description 452, coordination descriptions 454, as well as referential and structural control descriptions 430, among others.

Analysis rules 460 may generally describe properties of a specific language and may be used in performing the semantic analysis. Analysis rules 460 may comprise rules of identifying semantemes 462 and normalization rules 464. Normalization rules 464 may be used for describing language-dependent transformations of semantic structures.

FIG. 7 illustrates exemplary semantic descriptions. Components of semantic descriptions 204 are language-independent and may include, but are not limited to, a semantic hierarchy 510, deep slots descriptions 520, a set of semantemes 530, and pragmatic descriptions 540.

The core of the semantic descriptions may be represented by semantic hierarchy 510 which may comprise semantic notions (semantic entities) which are also referred to as semantic classes. The latter may be arranged into hierarchical structure reflecting parent-child relationships. In general, a child semantic class may inherits one or more properties of its direct parent and other ancestor semantic classes. In an illustrative example, semantic class SUBSTANCE is a child of semantic class ENTITY and the parent of semantic classes GAS, LIQUID, METAL, WOOD_MATERIAL, etc.

Each semantic class in semantic hierarchy 510 may be associated with a corresponding deep model 512. Deep model 512 of a semantic class may comprise a plurality of deep slots 514 which may reflect semantic roles of child constituents in various sentences that include objects of the semantic class as the core of the parent constituent. Deep model 512 may further comprise possible semantic classes acting as fillers of the deep slots. Deep slots 514 may express semantic relationships, including, for example, “agent,” “addressee,” “instrument,” “quantity,” etc. A child semantic class may inherit and further expand the deep model of its direct parent semantic class.

Deep slots descriptions 520 reflect semantic roles of child constituents in deep models 512 and may be used to describe general properties of deep slots 514. Deep slots descriptions 520 may also comprise grammatical and semantic restrictions associated with the fillers of deep slots 514. Properties and restrictions associated with deep slots 514 and their possible fillers in various languages may be substantially similar and often identical. Thus, deep slots 514 are language-independent.

System of semantemes 530 may represents a plurality of semantic categories and semantemes which represent meanings of the semantic categories. In an illustrative example, a semantic category “DegreeOfComparison” may be used to describe the degree of comparison and may comprise the following semantemes: “Positive,” “ComparativeHigherDegree,” and “SuperlativeHighestDegree,” among others. In another illustrative example, a semantic category “RelationToReferencePoint” may be used to describe an order (spatial or temporal in a broad sense of the words being analyzed), such as before or after a reference point, and may comprise the semantemes “Previous” and “Subsequent.”. In yet another illustrative example, a semantic category “EvaluationObjective” can be used to describe an objective assessment, such as “Bad,” “Good,” etc.

System of semantemes 530 may include language-independent semantic attributes which may express not only semantic properties but also stylistic, pragmatic and communicative properties. Certain semantemes may be used to express an atomic meaning which corresponds to a regular grammatical and/or lexical expression in a natural language. By their intended purpose and usage, sets of semantemes may be categorized, e.g., as grammatical semantemes 532, lexical semantemes 534, and classifying grammatical (differentiating) semantemes 536.

Grammatical semantemes 532 may be used to describe grammatical properties of the constituents when transforming a syntactic tree into a semantic structure. Lexical semantemes 534 may describe specific properties of objects (e.g., “being flat” or “being liquid”) and may be used in deep slot descriptions 520 as restriction associated with the deep slot fillers (e.g., for the verbs “face (with)” and “flood,” respectively). Classifying grammatical (differentiating) semantemes 536 may express the differentiating properties of objects within a single semantic class. In an illustrative example, in the semantic class of HAIRDRESSER, the semanteme of <<RelatedToMen>> is associated with the lexical meaning of “barber,” to differentiate from other lexical meanings which also belong to this class, such as “hairdresser,” “hairstylist,” etc. Using these language-independent semantic properties that may be expressed by elements of semantic description, including semantic classes, deep slots, and semantemes, may be employed for extracting the semantic information, in accordance with one or more aspects of the present invention.

Pragmatic descriptions 540 allow associating a certain theme, style or genre to texts and objects of semantic hierarchy 510 (e.g., “Economic Policy,” “Foreign Policy,” “Justice,” “Legislation,” “Trade,” “Finance,” etc.). Pragmatic properties may also be expressed by semantemes. In an illustrative example, the pragmatic context may be taken into consideration during the semantic analysis phase.

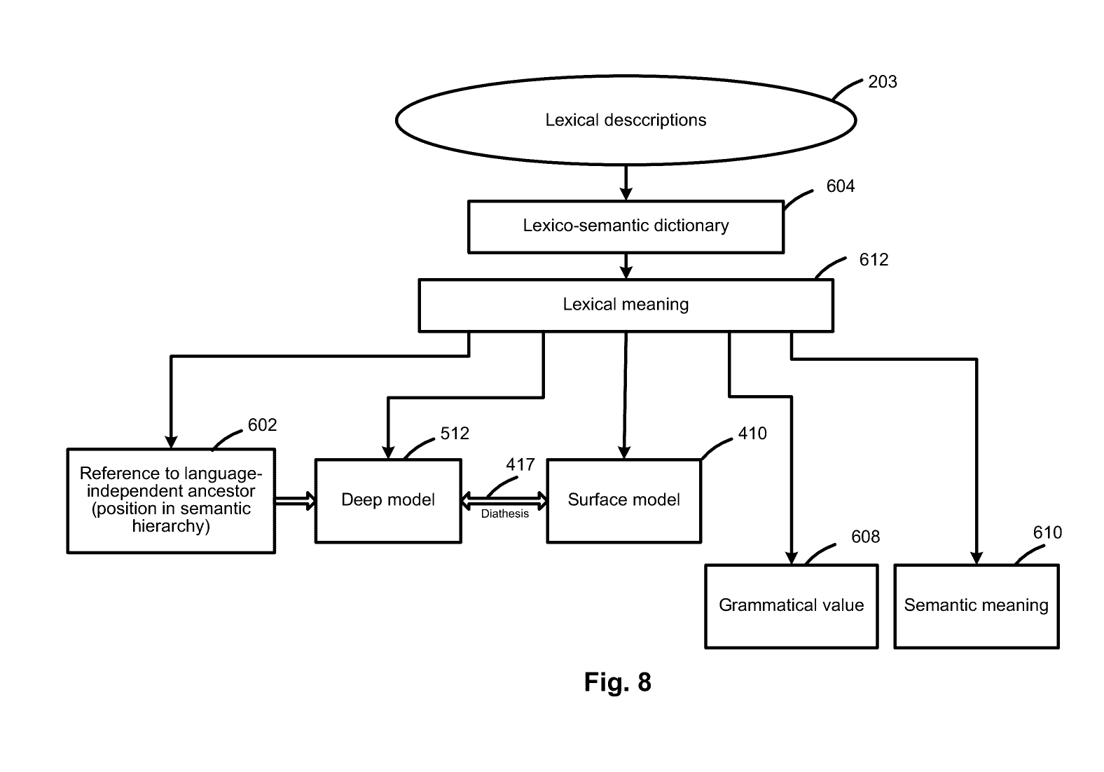

FIG. 8 illustrates exemplary lexical descriptions. Lexical descriptions 203 represent a plurality of lexical meanings 612, in a certain natural language, for each component of a sentence. For a lexical meaning 612, a relationship 602 to its language-independent semantic parent may be established to indicate the location of a given lexical meaning in semantic hierarchy 510.

A lexical meaning 612 of lexical-semantic hierarchy 510 may be associated with a surface model 410 which, in turn, may be associated, by one or more diatheses 417, with a corresponding deep model 512. A lexical meaning 612 may inherit the semantic class of its parent, and may further specify its deep model 152.

A surface model 410 of a lexical meaning may comprise includes one or more syntforms 412. A syntform, 412 of a surface model 410 may comprise one or more surface slots 415, including their respective linear order descriptions 416, one or more grammatical values 414 expressed as a set of grammatical categories (grammemes), one or more semantic restrictions associated with surface slot fillers, and one or more of the diatheses 417. Semantic restrictions associated with a certain surface slot filler may be represented by one or more semantic classes, whose objects can fill the surface slot.

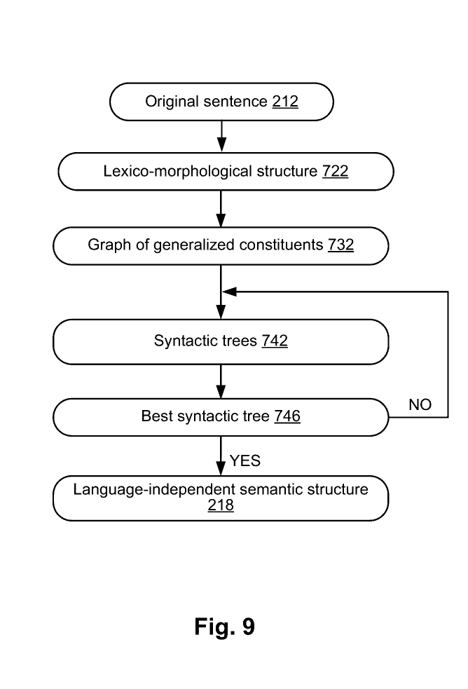

FIG. 9 schematically illustrates example data structures that may be employed by one or more methods described herein. Referring again to FIG. 2, at block 214, the computing device implementing the method may perform lexico-morphological analysis of sentence 212 to produce a lexico-morphological structure 722 of FIG. 9. Lexico-morphological structure 722 may comprise a plurality of mapping of a lexical meaning to a grammatical value for each lexical unit (e.g., word) of the original sentence. FIG. 3 schematically illustrates an example of a lexico-morphological structure.

At block 215, the computing device may perform a rough syntactic analysis of original sentence 212, in order to produce a graph of generalized constituents 732 of FIG. 9. Rough syntactic analysis involves applying one or more possible syntactic models of possible lexical meanings to each element of a plurality of elements of the lexico-morphological structure 722, in order to identify a plurality of potential syntactic relationships within original sentence 212, which are represented by graph of generalized constituents 732.

Graph of generalized constituents 732 may be represented by an acyclic graph comprising a plurality of nodes corresponding to the generalized constituents of original sentence 212, and further comprising a plurality of edges corresponding to the surface (syntactic) slots, which may express various types of relationship among the generalized lexical meanings. The method may apply a plurality of potentially viable syntactic models for each element of a plurality of elements of the lexico-morphological structure of original sentence 212 in order to produce a set of core constituents of original sentence 212. Then, the method may consider a plurality of viable syntactic models and syntactic structures of original sentence 212 in order to produce graph of generalized constituents 732 based on a set of constituents. Graph of generalized constituents 732 at the level of the surface model may reflect a plurality of viable relationships among the words of original sentence 212. As the number of viable syntactic structures may be relatively large, graph of generalized constituents 732 may generally comprise redundant information, including relatively large numbers of lexical meaning for certain nodes and/or surface slots for certain edges of the graph.

Graph of generalized constituents 732 may be initially built as a tree, starting with the terminal nodes (leaves) and moving towards the root, by adding child components to fill surface slots 415 of a plurality of parent constituents in order to reflect all lexical units of original sentence 212.

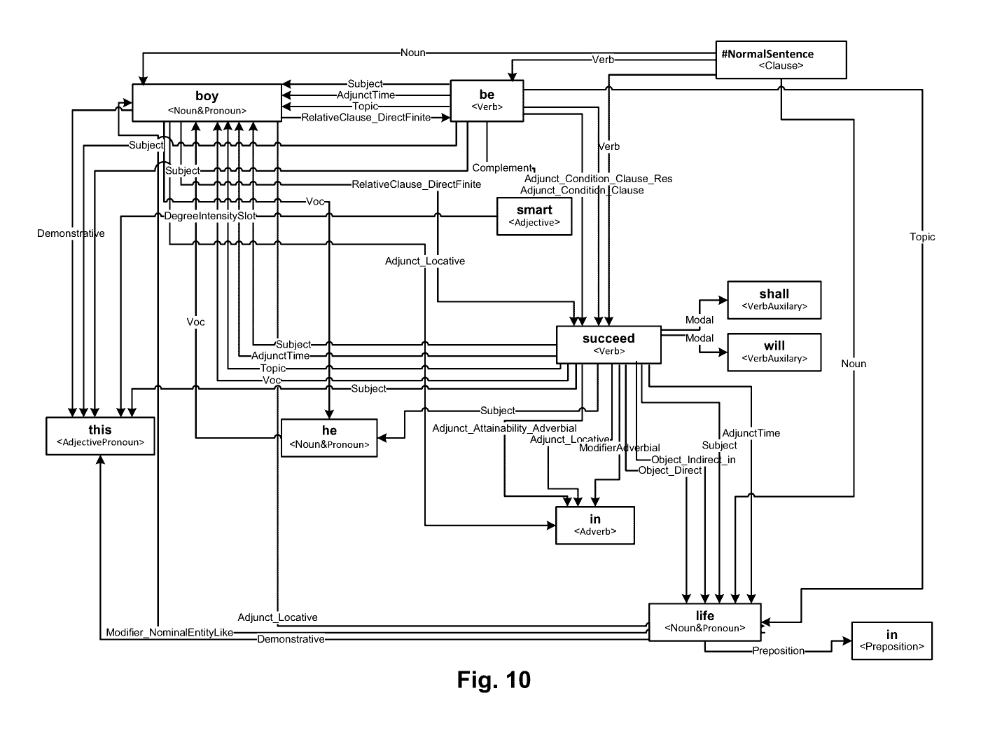

In certain implementations, the root of graph of generalized constituents 732 represents a predicate. In the course of the above described process, the tree may become a graph, as certain constituents of a lower level may be included into one or more constituents of an upper level. A plurality of constituents that represent certain elements of the lexico-morphological structure may then be generalized to produce generalized constituents. The constituents may be generalized based on their lexical meanings or grammatical values 414, e.g., based on part of speech designations and their relationships. FIG. 10 schematically illustrates an example graph of generalized constituents.

At block 216, the computing device may perform a precise syntactic analysis of sentence 212, to produce one or more syntactic trees 742 of FIG. 9 based on graph of generalized constituents 732. For each of one or more syntactic trees, the computing device may determine a general rating based on certain calculations and a priori estimates. The tree having the optimal rating may be selected for producing the best syntactic structure 746 of original sentence 212.

In the course of producing the syntactic structure 746 based on the selected syntactic tree, the computing device may establish one or more non-tree links (e.g., by producing redundant path among at least two nodes of the graph). If that process fails, the computing device may select a syntactic tree having a suboptimal rating closest to the optimal rating, and may attempt to establish one or more non-tree relationships within that tree. Finally, the precise syntactic analysis produces a syntactic structure 746 which represents the best syntactic structure corresponding to original sentence 212. In fact, selecting the best syntactic structure 746 also produces the best lexical values 240 of original sentence 212.

At block 217, the computing device may process the syntactic trees to the produce a semantic structure 218 corresponding to sentence 212. Semantic structure 218 may reflect, in language-independent terms, the semantics conveyed by original sentence. Semantic structure 218 may be represented by an acyclic graph (e.g., a tree complemented by at least one non-tree link, such as an edge producing a redundant path among at least two nodes of the graph). The original natural language words are represented by the nodes corresponding to language-independent semantic classes of semantic hierarchy 510. The edges of the graph represent deep (semantic) relationships between the nodes. Semantic structure 218 may be produced based on analysis rules 460, and may involve associating, one or more attributes (reflecting lexical, syntactic, and/or semantic properties of the words of original sentence 212) with each semantic class.

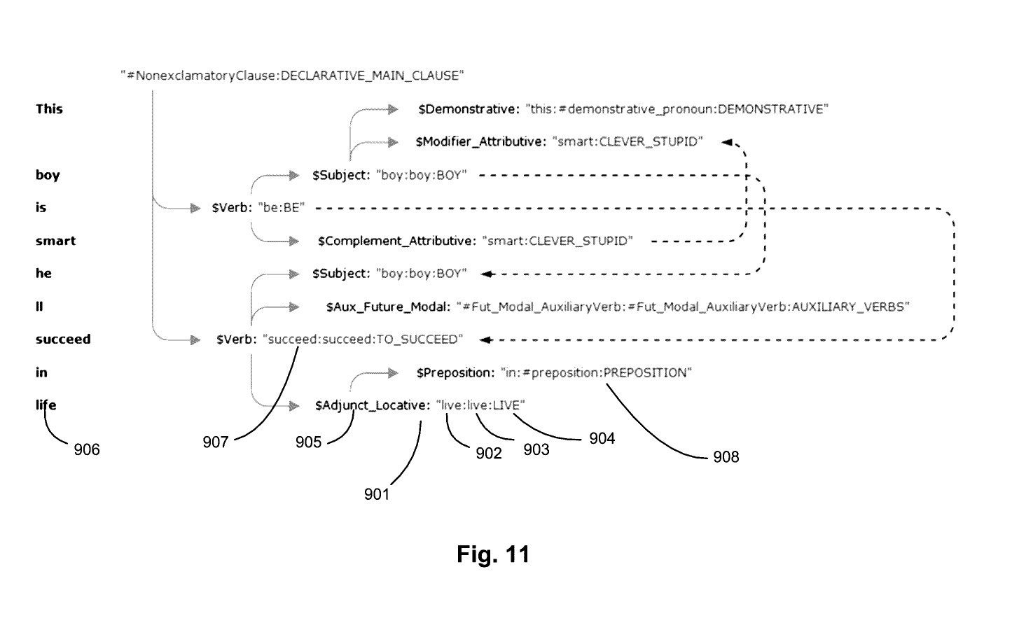

FIG. 11 illustrates an example syntactic structure of a sentence derived from the graph of generalized constituents illustrated by FIG. 10. Node 901 corresponds to the lexical element “life” 906 in original sentence. By applying the method of syntactico-semantic analysis described herein, the computing device may establish that lexical element “life” 906 represents one of the form of a lexical meaning associated with a semantic class “LIVE” 904, and fills in a surface slot $Adjunctr_Locative (905) of the parent constituent, which is represented by a controlling node $Verb:succeed:succeed:TO_SUCCEED (907).

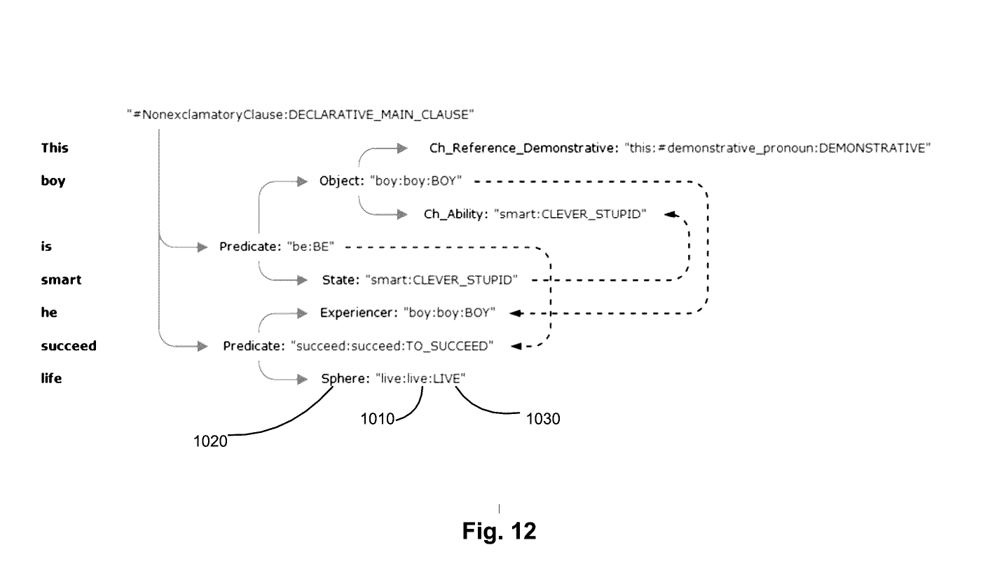

FIG. 12 illustrates a semantic structure corresponding to the syntactic structure of FIG. 11. With respect to the above referenced lexical element “life” 906 of FIG. 11, the semantic structure comprises lexical class 1010 and semantic classes 1030 similar to those of FIG. 11, but instead of surface slot 905, the semantic structure comprises a deep slot “Sphere” 1020.

As noted herein above, and ontology may be provided by a model representing objects pertaining to a certain branch of knowledge (subject area) and relationships among such objects. Thus, an ontology is different from a semantic hierarchy, despite the fact that it may be associated with elements of a semantic hierarchy by certain relationships (also referred to as “anchors”). An ontology may comprise definitions of a plurality of classes, such that each class corresponds to a concept of the subject area. Each class definition may comprise definitions of one or more objects associated with the class. Following the generally accepted terminology, an ontology class may also be referred to as concept, and an object belonging to a class may also be referred to as an instance of the concept.

Referring again to FIG. 1, at block 140 the computing device implementing the method may interpret the semantic structures produced by the semantico-syntactic analysis as described herein above with reference to block 130. In certain implementations, fragments of syntactico-semantic structures may be interpreted by applying a set of production rules to produce an annotated Resource Definition Framework (RDF) graph.

In the Resource Definition Framework a unique identifier is assigned to each informational object and the information regarding such an object is stored in the form of SPO triples, where S stands for “subject” and contains the identifier of the object, P stands for “predicate” and identifies some property of the object, and O stands for “object” and stores the value of that property of the object. This value can be either a primitive data type (string, number, Boolean value) or an identifier of another object.

But, the annotated RDF graph may is formed on the final stage of the information extraction process. On the intermediate stages another data structure is used which may be viewed as a set of non-contradictory statements regarding the informational objects and their properties, also referred to as a “bag of statements”. In RDF-graph each SPO triple and each link from an object to a segment of text may be also considered a statement regarding that object.

While the annotated RDF graph is the result of interpreting the semantico-syntactic structures produced by the semantico-syntactic analysis, the information extraction process may employ a more complex data structure to store intermediate results. One important distinction between the intermediate data structure and the resulting RDF graph is that the statements from the intermediate structure may be used to create functional dependencies, i.e. some statements may depend on the presence of other properties and/or dependences. For instance, a set of values of a certain object's property may contain a set of values of some other property of a different object. If the set of values of the second object is changed, the first object's property changes as well. Statements relying upon functional dependencies are also referred to as dynamic statements. Another important distinction between the intermediate data structure and the resulting RDF graph is that the intermediate data structure may contain some auxiliary statements that do not comply with the final annotated RDF graph structure and are used only during the extraction process.

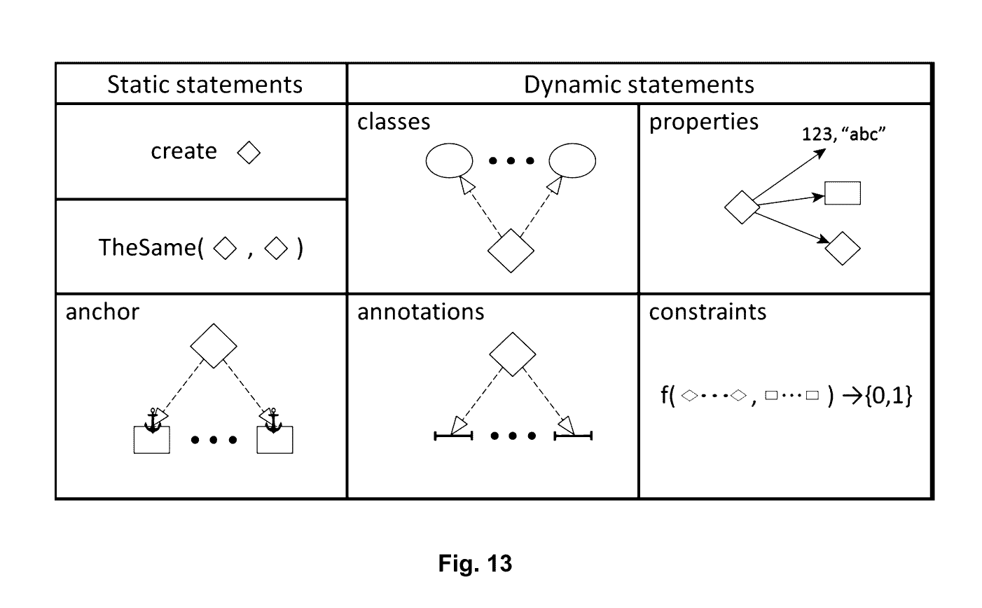

FIG. 13 schematically illustrates schematic diagrams of several statements types that may be employed in the information extraction process. In FIG. 13, diamonds represent informational objects (for example, entities, persons, locations, organizations, facts, etc.), ellipses represent classes (or concepts), and rectangular boxes represent parse tree nodes.

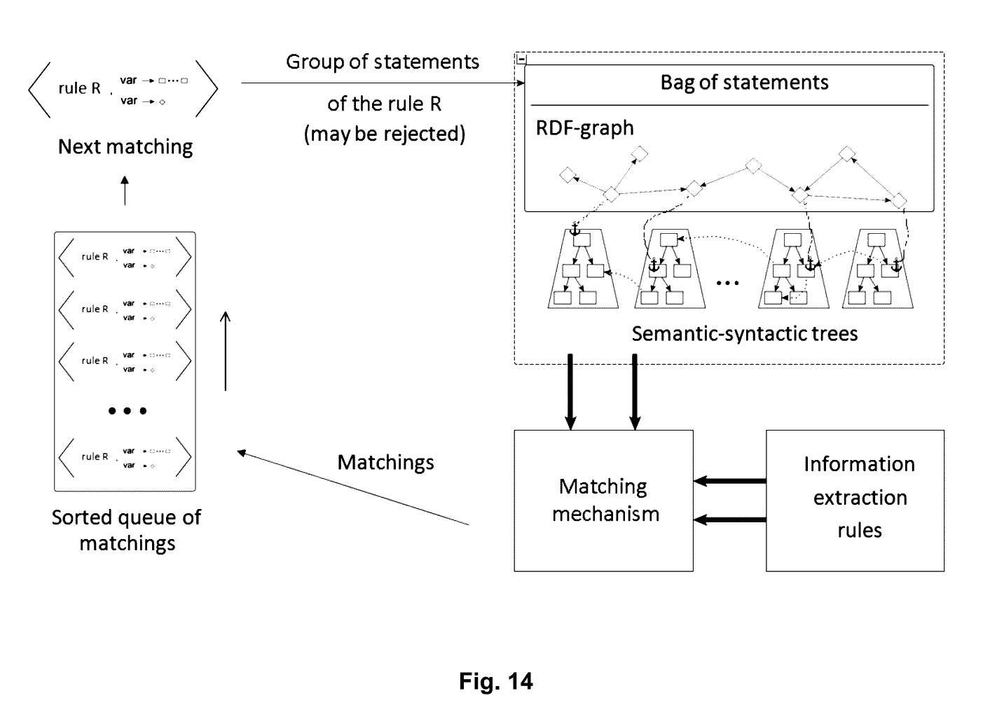

FIG. 14 schematically illustrates the process of interpreting the semantic structures produced by the semantico-syntactic analysis in accordance with one or more aspects of the present disclosure. In certain implementations, fragments of syntactico-semantic structures may be interpreted in accordance with a set of production rules, including interpretation rules and identification rules. An interpretation rule specifies one or more fragments of parse trees the presence of which triggers certain logical statements. An interpretation rule may comprise one or more syntactic-semantic tree patterns in its left-hand side and one or more statements regarding the informational objects in the right-hand side.

A production rule may comprise a set of logical expressions defined on one or more semantic structure templates. A semantic structure template may be represented by a formula comprising one or more properties of certain semantic structures elements (e.g., presence of certain grammemes or semantemes, association with a certain lexical/semantic class, a presence a certain surface or deep slot, etc.). The relationships between the semantic structure elements may be specified by logical expressions (conjunction, disjunction, and negation) and/or by operations describing mutual positions of nodes within a syntactico-semantic tree. In an illustrative example, an operation may verify whether one node belongs to a subtree of another node.

A statement in the right-hand side of a production rule may reference the nodes of the subtree that matches the template in the left-hand side of the production rule, and sometimes may also reference the informational objects associated with to nodes. Such references may be made using variables for identifying certain parts of a tree template.

An identification rule may be employed to associate a pair of objects. An identification rule is a production rule, the left-hand side of which comprises one or more object conditions for the two objects. If the pair of objects satisfies these conditions, the objects are merged into a single object. The right-hand side of an identification rule may be omitted since it is presumed to be a statement that the two objects are identical (an identification statement).

Referring again to FIG. 1, at block 150, the computing device may analyze the table header. In various illustrative examples, the table header may comprise one or more rows, may have a complex structure with sub-headers, and may not be easily distinguishable from the table body. Thus, various heuristic methods may be employed to detect and parse the table header based on certain visual separators, presence of fonts that are different from the rest of the table, etc.

The computing device may parse the table header using an auxiliary ontology 1510 comprising various classes associated with certain aspects of the table structure, as schematically illustrated by FIG. 15. The computing device may further associate one or more table column with one or more classes of a certain generic or subject matter-specific ontology associated with the subject matter presented in the table.

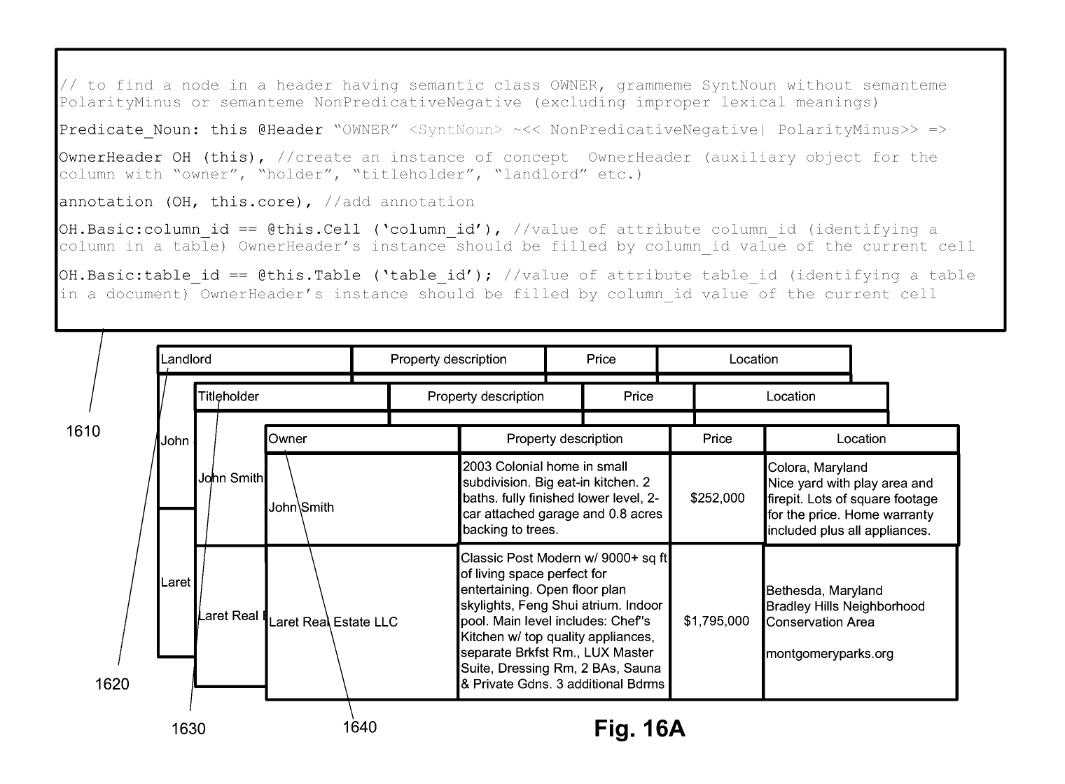

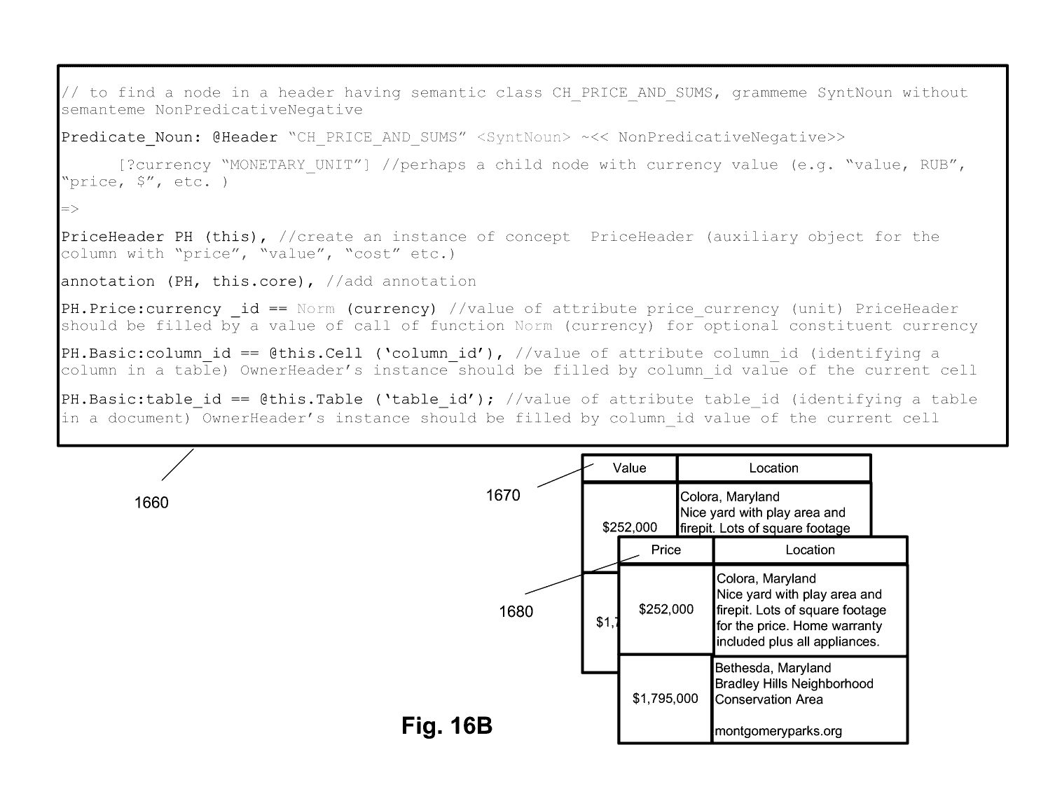

FIGS. 16A-16B schematically illustrate example tables and rules employed for processing the table header, in accordance with one or more aspects of the present disclosure. As schematically illustrated by FIG. 16A, set of rules 1610 may identify an ontology class (“OWNER”) referenced by a certain lexeme in the table header, and associate the corresponding table column of tables 1620, 1630, 1640 with the identified ontology class. As schematically illustrated by FIG. 16B, set of rules 1660 may identify an ontology class (“CH_PRICE_AND_SUMS”) referenced by a certain lexeme in the table header, and associate the corresponding table column of tables 1670, 1680 with the identified ontology class.

Referring again to FIG. 1, at block 160, the computing device may modify the data object (i.e., the RDF graph) that was built by extracting the information from the table cells. In particular, the data object may be enhanced by applying, to the information extracted from the table cells, certain production rules associated with the ontology classes associated with the table columns.

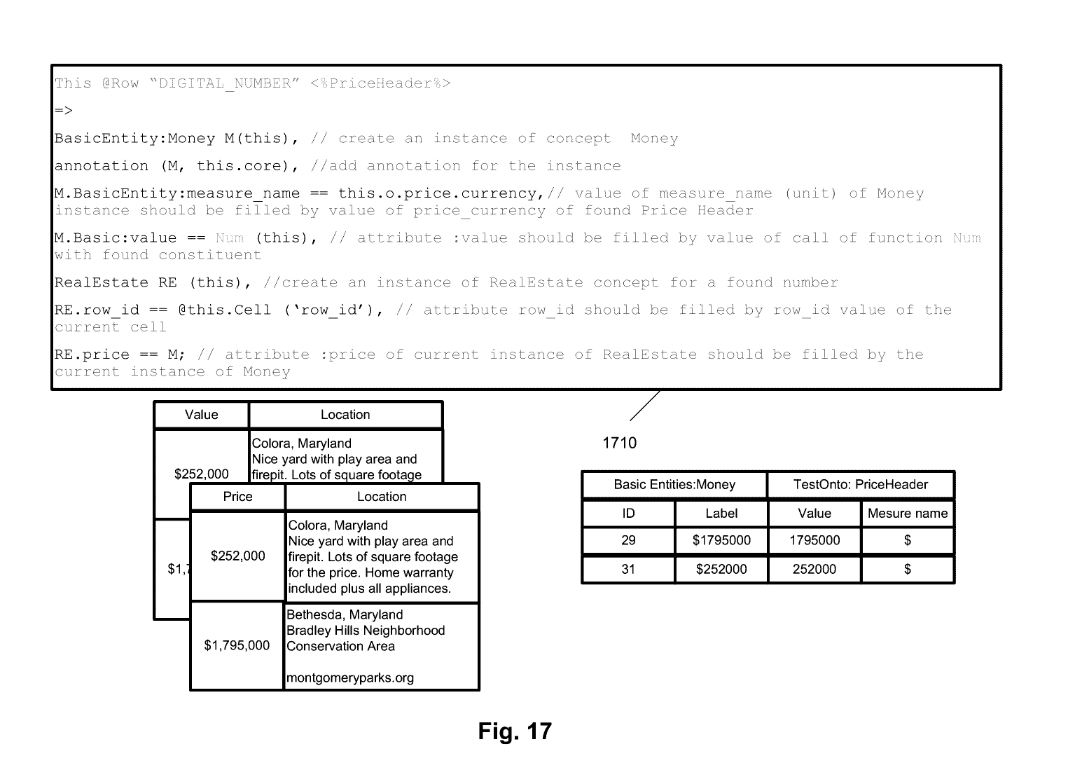

FIG. 17 schematically illustrates an example table and a set of rules employed for processing the table body, in accordance with one or more aspects of the present disclosure. In particularly, FIG. 17 represents an example set of rules 1710 may be employed to parse the table cells within the column associated with the ontology class “CH_PRICE_AND_SUMS”

As the result of applying rules 1710, the RDF graph representing the table that was produced by the operations described herein above with reference to block 140 of FIG. 1, may be enhanced to include new objects, such as instances of ontology classes identified by the corresponding table columns. The RDF graph representing the table may be further enhanced by specifying the relationships between the existing and/or newly added objects (e.g., a real estate object identifier, address, owner, and price may be associated by certain relationships).

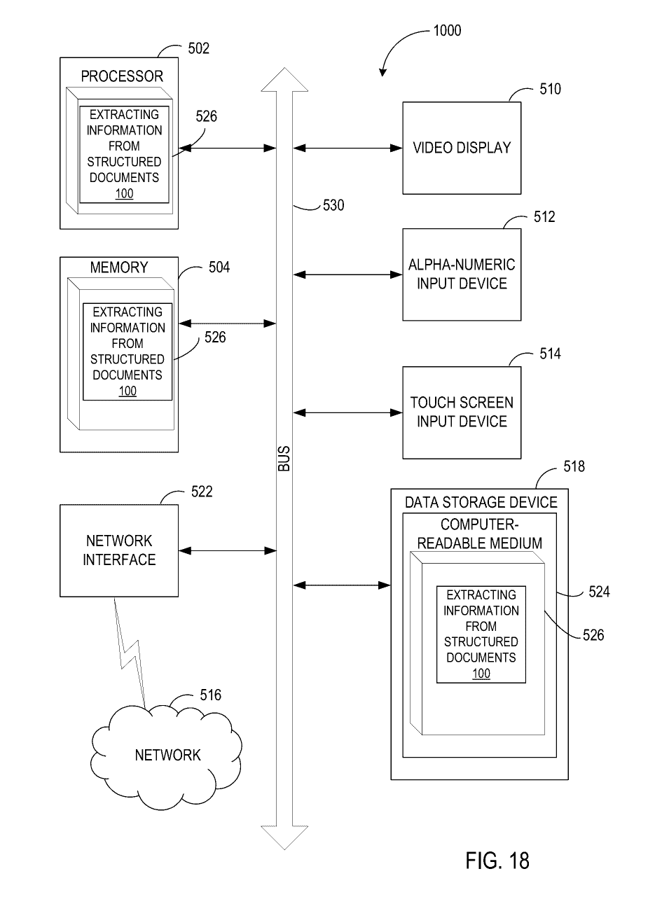

FIG. 18 illustrates a diagram of an example computing device 1000 which may execute a set of instructions for causing the computing device to perform any one or more of the methods discussed herein. The computing device may be connected to other computing device in a LAN, an intranet, an extranet, or the Internet. The computing device may operate in the capacity of a server or a client computing device in client-server network environment, or as a peer computing device in a peer-to-peer (or distributed) network environment. The computing device may be a provided by a personal computer (PC), a tablet PC, a set-top box (STB), a Personal Digital Assistant (PDA), a cellular telephone, or any computing device capable of executing a set of instructions (sequential or otherwise) that specify operations to be performed by that computing device. Further, while only a single computing device is illustrated, the term “computing device” shall also be taken to include any collection of computing devices that individually or jointly execute a set (or multiple sets) of instructions to perform any one or more of the methodologies discussed herein.

Exemplary computing device 1000 includes a processor 502, a main memory 504 (e.g., read-only memory (ROM) or dynamic random access memory (DRAM)), and a data storage device 518, which communicate with each other via a bus 530.

Processor 502 may be represented by one or more general-purpose computing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose computing devices such as an application specific integrated circuit (ASIC), a field programmable gate array (FPGA), a digital signal processor (DSP), network processor, or the like. Processor 502 is configured to execute instructions 526 for performing the operations and functions discussed herein.

Computing device 1000 may further include a network interface device 522, a video display unit 510, a character input device 512 (e.g., a keyboard), and a touch screen input device 514.

Data storage device 518 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computing device 1000, main memory 504 and processor 502 also constituting computer-readable storage media. Instructions 526 may further be transmitted or received over network 516 via network interface device 522.

In certain implementations, instructions 526 may include instructions of method 100 for extracting information from structured documents comprising natural language text. While computer-readable storage medium 524 is shown in the example of FIG. 18 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a processing device, a table comprising a natural language text;
identifying, within the table, a header and a plurality of cells organized into rows and columns;
performing semantico-syntactic analysis of the natural language text to produce a plurality of semantic structures;
interpreting the plurality of semantic structures using a first set of production rules to produce a data object representing the table;
analyzing the header to identify a plurality of ontology classes associated with respective table columns; and
modifying the data object representing the table using a second set of production rules associated with the ontology classes associated with the table columns.

2. The method of claim 1, wherein the data object is represented by a Resource Definition Framework (RDF) graph.

3. The method of claim 1, wherein modifying the data object representing the table comprises enhancing the initial RDF graph by performing at least one of: adding a new object or adding a new relationship.

4. The method of claim 1, wherein each semantic structure of the plurality of semantic structures is represented by a graph comprising a plurality of nodes corresponding to a plurality of semantic classes and a plurality of edges corresponding to a plurality of semantic relationships.

5. The method of claim 1, wherein a production rule of a first set of production rules comprises one or more logical expressions defined on one or more semantic structure templates.

6. The method of claim 1, wherein a production rule of a second set of production rules comprises one or more logical expressions defined on one or more semantic structure templates.

7. The method of claim 1, wherein analyzing the header is performed by using an auxiliary ontology comprising a plurality of classes associated with a document structure.

8. A system, comprising:
a memory;
a processor, coupled to the memory, the processor configured to:
receive a table comprising a natural language text;
identify, within the table, a header and a plurality of cells organized into rows and columns;
perform semantico-syntactic analysis of the natural language text to produce a plurality of semantic structures;
interpret the plurality of semantic structures using a first set of production rules to produce a data object representing the table;
analyze the header to identify a plurality of ontology classes associated with respective table columns; and
modify the data object representing the table using a second set of production rules associated with the ontology classes associated with the table columns.

9. The system of claim 8, wherein the data object is represented by a Resource Definition Framework (RDF) graph.

10. The system of claim 8, wherein modifying the data object representing the table comprises enhancing the initial RDF graph by performing at least one of: adding a new object or adding a new relationship.

11. The system of claim 8, wherein each semantic structure of the plurality of semantic structures is represented by a graph comprising a plurality of nodes corresponding to a plurality of semantic classes and a plurality of edges corresponding to a plurality of semantic relationships.

12. The system of claim 8, wherein a production rule of a first set of production rules comprises one or more logical expressions defined on one or more semantic structure templates.

13. The system of claim 8, wherein a production rule of a second set of production rules comprises one or more logical expressions defined on one or more semantic structure templates.

14. The system of claim 8, wherein analyzing the header is performed by using an auxiliary ontology comprising a plurality of classes associated with a document structure.

15. A computer-readable non-transitory storage medium comprising executable instructions that, when executed by a computing device, cause the computing device to perform operations comprising:
receiving a table comprising a natural language text;
identifying, within the table, a header and a plurality of cells organized into rows and columns;
performing semantico-syntactic analysis of the natural language text to produce a plurality of semantic structures;
interpreting the plurality of semantic structures using a first set of production rules to produce a data object representing the table;
analyzing the header to identify a plurality of ontology classes associated with respective table columns; and
modifying the data object representing the table using a second set of production rules associated with the ontology classes associated with the table columns.

16. The computer-readable non-transitory storage medium of claim 15, wherein the data object is represented by a Resource Definition Framework (RDF) graph.

17. The computer-readable non-transitory storage medium of claim 15, wherein modifying the data object representing the table comprises enhancing the initial RDF graph by performing at least one of: adding a new object or adding a new relationship.

18. The computer-readable non-transitory storage medium of claim 15, wherein each semantic structure of the plurality of semantic structures is represented by a graph comprising a plurality of nodes corresponding to a plurality of semantic classes and a plurality of edges corresponding to a plurality of semantic relationships.

19. The computer-readable non-transitory storage medium of claim 15, wherein a production rule of a first set of production rules comprises one or more logical expressions defined on one or more semantic structure templates.

20. The computer-readable non-transitory storage medium of claim 15, wherein a production rule of a second set of production rules comprises one or more logical expressions defined on one or more semantic structure templates.
